(19) United States
(12) Patent Application Publication
(10) Pub. No.: US 2024/0201025 A1
(43) Pub. Date: Jun. 20, 2024

(54) COT SURFACE THERMOCOUPLE

(71) Applicant: Zibo Yiyuan Engineering and Technology Co., Ltd., Zibo (CN)

(72) Inventors: Yongkong SUN, Zibo (CN); Dongxu WANG, Zibo (CN); Wenyong CHEN, Zibo (CN); Kun WANG, Zibo (CN); Zhangqin PU, Zibo (CN); Hailei LIU, Zibo (CN); Rui SUN, Zibo (CN)

(21) Appl. No.: 18/067,806

(22) Filed: Dec. 19, 2022

(51) Int. Cl. G01K 7/02; G01K 1/08; G01K 1/143

(52) U.S. Cl. CPC G01K 7/023; G01K 1/08; G01K 1/143

(57) ABSTRACT

A COT surface thermocouple including a contact type temperature measuring component, a sleeve, a connecting sealing assembly, a clamping sleeve assembly, a temperature measuring component and a junction box is provided. The COT surface thermocouple is arranged on the surface of a furnace tube of an ethylene cracking furnace. The contact type temperature measuring component is completely in contact welding with the surface of the furnace tube. The whole body is in an inclined angle. The contact type temperature measuring component is connected with the sleeve in a way of concentrically welding a counter bore or connecting an internal thread. The sleeve and the contact type temperature measuring component are concentrically connected without bending. The sleeve is formed by splicing two sections and is connected through the connecting sealing assembly to form a sealing cavity.

### TECHNICAL FIELD

The invention relates to the field of chemical processing equipment, and more specifically, to a COT surface thermocouple, which is specially used for an ethylene cracking furnace.

### BACKGROUND

The outlet temperature (COT) of the ethylene cracking furnace represents the cracking depth of the raw material, which directly concerns the ethylene yield and is an important control index in operation. In the advanced control and the classical control of the cracking furnace, the core is to develop around the temperature of the furnace outlet. The COT temperature is reasonably set by detecting the components of cracking gas at the outlet of the cracking furnace and combining the properties of raw materials. The constant temperature of the outlet of each group of furnace tubes is ensured by adjusting the proportion of feeding and diluting steam, and the temperature deviation of each group of furnace tubes is ensured to meet the requirement, so that the cracking depth is ensured. Therefore, the COT measurement is extremely important, and the accuracy of the temperature control of the outlet of the cracking furnace directly influences the long-period stable operation of the cracking furnace.

From the practical operation, the smaller the temperature difference between the furnace outlet temperatures of each group of the cracking furnace is, the more uniform the control is, and the longer the operation period of the cracking furnace is. On the contrary, if the COT measurement has deviation, the feeding of each group of furnace tubes of the cracking furnace is uneven, so that the coking degree of each group of furnace tubes is different, the furnace tubes can leak, block, break and reduce the service life in serious conditions, unplanned furnace shutdown can be caused, and the influence on equipment and economic benefit is huge.

The cracking depth is insufficient due to the low temperature of the outlet of the cracking furnace, heavy components are excessive, and the ethylene yield is influenced. If the temperature is too high, the reverse reaction is increased, the coking speed of the furnace tube is increased, the yield is influenced, the operation period of equipment is shortened, and production accidents can be caused.

In conclusion, the accuracy of the temperature measurement at the outlet of the cracking furnace directly affects the economic operation of the cracking furnace.

In the prior art, a COT surface thermocouple, a sleeve temperature measuring end and the surface of a furnace tube are welded, the upper part of the sleeve bends to form an included angle with the furnace tube, and the sleeve can be bent for many times under the requirement of an installation space. The temperature measuring component (thermocouple wire) is deformed through the bent part of the sleeve in the installation process, so that the installation is very difficult. The thermocouple wire is more difficult to draw out due to the influence of temperature after installation and operation, and more importantly, the thermocouple wire passes through a bent part of the sleeve, a measuring point part is obliquely deformed towards the outer side of the sleeve, the inner side of the sleeve is welded with the furnace tube and is used for sensing temperature, and the outer side of the sleeve is used for conducting temperature. The measurement points are in contact with the conduction temperature (as is disclosed in FIG. 1).

In summary, the prior art has the following two defects: firstly, the temperature change on the surface of the furnace tube cannot be immediately reflected, and the deviation between the measured and displayed temperature and the actual temperature is large. Secondly, because the sleeve pipe is bent, the thermocouple is difficult to install, and when the thermocouple core cannot be drawn out during detection and replacement, the thermocouple sleeve pipe needs to be replaced, and the heat preservation layer needs to be removed when the thermocouple sleeve pipe is replaced. Not only wastes resources, but also increases the overhaul cost and the equipment operation cost.

### SUMMARY

The invention provides a special chemical process cracking furnace auxiliary device, which is a COT surface thermocouple and is designed mainly aiming at the defects which are not overcome in the prior art, and comprises the following technical scheme: the COT surface thermocouple comprises a contact type temperature measuring component, a sleeve, a connecting sealing component, a clamping sleeve component, a temperature measuring component and a junction box, and is characterized in that the COT surface thermocouple is arranged on the surface of a furnace tube of an ethylene cracking furnace, the contact type temperature measuring component is completely in contact welding with the surface of the furnace tube, the whole COT surface thermocouple is in an inclined angle, the contact type temperature measuring component is connected with the sleeve in a concentric welding counter bore or a connecting internal thread, the sleeve and the contact type temperature measuring component are in concentric non-bending connection, the sleeve is formed by splicing two sections, the two sections of sleeves are connected through the connecting sealing component to form a sealing cavity, and the sleeve is connected with the clamping sleeve component.

Preferably, the contact temperature measuring component is designed and processed into an arc-shaped curved surface according to the outer diameter of the furnace tube and the given installation space, so that the contact temperature measuring component is completely matched with the surface of the furnace tube.

Preferably, the contact temperature measuring component and one section of the sleeve are wrapped in the heat preservation layer along with the cracking furnace tube, and the heat preservation layer is exposed out of the first section of the sleeve by 50 mm.

Preferably, the temperature measuring component is arranged in the sleeve, and a measuring point at the end part of the temperature measuring component is in close contact with the surface of the furnace tube through an inner hole inclined plane of the contact type temperature measuring component.

Preferably, the clamping sleeve component is a ferrule bolt structure.

Preferably, the contact temperature measuring component is made of stainless steel bar stock, hexagonal stock or square stock, and is designed and finished according to the diameter of the furnace tube and the given installation space.

Preferably, the junction box conforms to the national standards of protection and explosion prevention, an electrical interface uses ½ ‘NPT, ¾’ NPT, and the junction box is internally provided with a wiring terminal base.

Compared with the conventional COT plug-in thermocouple, the COT surface thermocouple is convenient to install and maintain, can be replaced on line and has long service life. According to the COT surface thermocouple, the contact surface of the contact temperature measuring component and the furnace tube wall is a curved surface, so that the welding is convenient, and the strength is higher after the welding; the contact temperature measuring component and the furnace tube wall can form any included angle, so that the thermocouple cannot be installed due to the overlarge included angle; the temperature measuring end (measuring point) is directly and tightly contacted with the furnace tube wall, so that the thermal response time is short, the precision is high, and the temperature measurement is more accurate; the contact temperature measuring component is directly welded on the furnace tube, so that the bending of the sleeve is avoided, and the thermocouple is greatly convenient to install.

### BRIEF DESCRIPTION OF DRAWINGS

FIG. 1 is a schematic view of the overall structure of the COT surface thermocouple of the disclosure.

FIG. 2 is a schematic diagram showing the overall structure of a COT surface thermocouple of the disclosure.

FIG. 3 is a schematic structural view of a sleeve contact type temperature measurement component of a COT surface thermocouple of the disclosure.

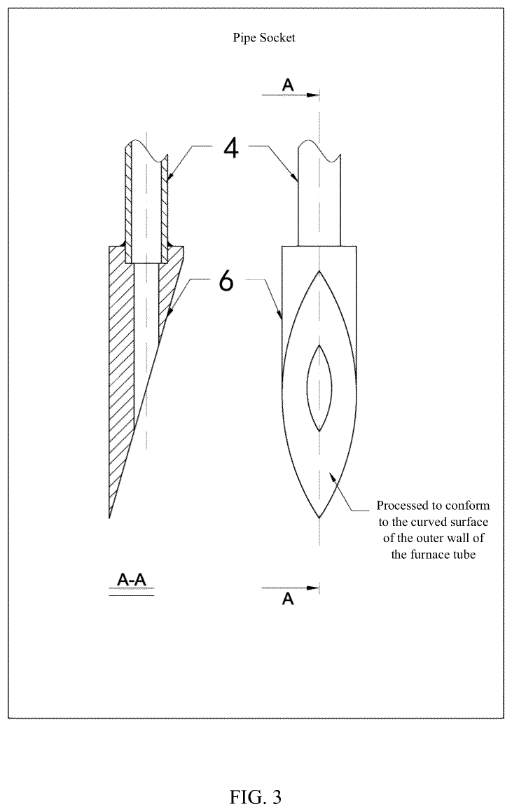

FIG. 4 is a comparison of COT surface thermocouple measurement point locations of the disclosure with those of the prior art.

FIG. 5 is a schematic view of the oblique installation of the contact temperature measurement component of the disclosure.

FIG. 6 is a schematic view of the design of different curved surfaces of the lower end of the contact temperature measurement component according to the disclosure.

In the drawings: temperature measuring component (thermocouple wire) 1, connecting seal assembly 2, cutting sleeve assembly 3, sealing double cutting sleeve 31, sleeve 4, sleeve contact type temperature measuring component 5, COT furnace tube 6, COT furnace tube surface 61, measuring point (temperature measuring end) 7, and junction box 8.

### DETAILED DESCRIPTION OF THE EMBODIMENTS

The technical solutions in the embodiments of the disclosure will be described clearly and completely with reference to the accompanying drawings in the embodiments of the disclosure, and it is obvious that the described embodiments are only a part of the embodiments of the disclosure, and not all of the embodiments. All other embodiments obtained by a person skilled in the art without making any inventive step are within the scope of the disclosure.

The COT surface thermocouple of the embodiment is not limited to the measurement of the surface temperature of the furnace tube of the ethylene cracking furnace, and is suitable for the measurement of the surface temperature of all furnace tubes of heating furnaces and related objects.

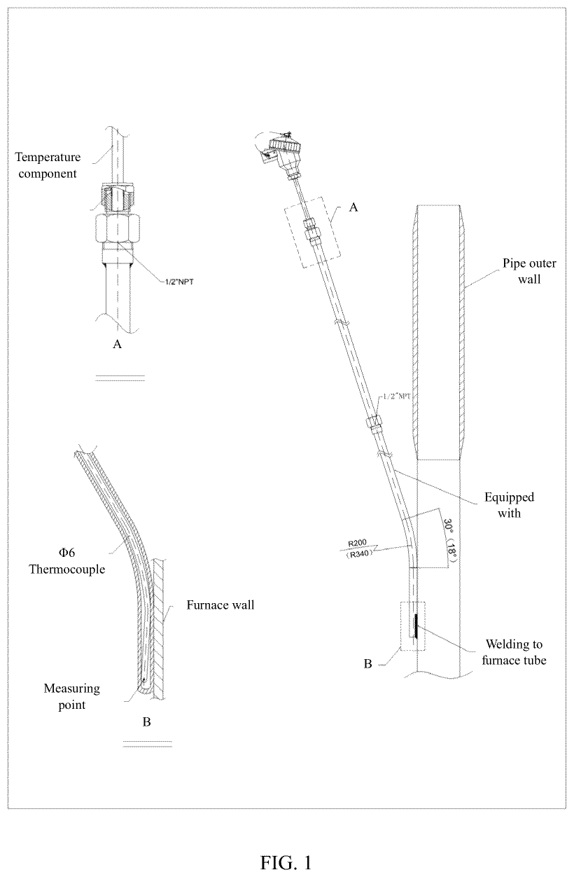

The COT surface thermocouple of the embodiment includes components as follows. The junction box 8 and the COT furnace tube 6 further includes a temperature measuring component (thermocouple wire) 1, a connecting seal assembly 2, a cutting clamping sleeve component 3, a sleeve 4 and a sleeve contact type temperature measuring component 5. The COT surface thermocouple is installed on the outer side of the COT furnace tube wall 61 of the COT furnace tube 6, referring to the overall structure schematic diagram of the COT surface thermocouple in the embodiment shown in the FIG. 1. In general, the COT furnace tube 6 is externally wrapped with a heat insulation layer. One end of the sleeve contact type temperature measuring component 5 is welded on the surface 61 of the COT furnace tube, the whole temperature is an inclined angle, the inclined angle is 15-90 degrees, after the sleeve 4 is obliquely arranged along with the sleeve contact type temperature measuring component 5, the cutting clamping sleeve component 3 is required to be exposed out of the heat insulation layer.

The sleeve pipe 4 is connected on cup jointing contact temperature measurement part 5, and sleeve pipe 4 divide into two sections concatenations and forms, avoids the whole overlength of sleeve pipe 4 and be not convenient for with the welding of cup jointing contact temperature measurement part 5, and concatenation department uses connection seal assembly 2, connects seal assembly 2 and plays the effect of connecting two sections fixed sleeve pipes 4, through threaded connection between two sections sleeve pipes 4, the screw thread is the NPT toper sealing thread to use connection seal assembly 2 to fasten. One end of the sleeve 4 is welded with the sleeve contact type temperature measuring component 5, the other end of the sleeve is provided with a clamping sleeve component 3, and the upper end of the clamping sleeve component 3 is connected with a junction box 8.

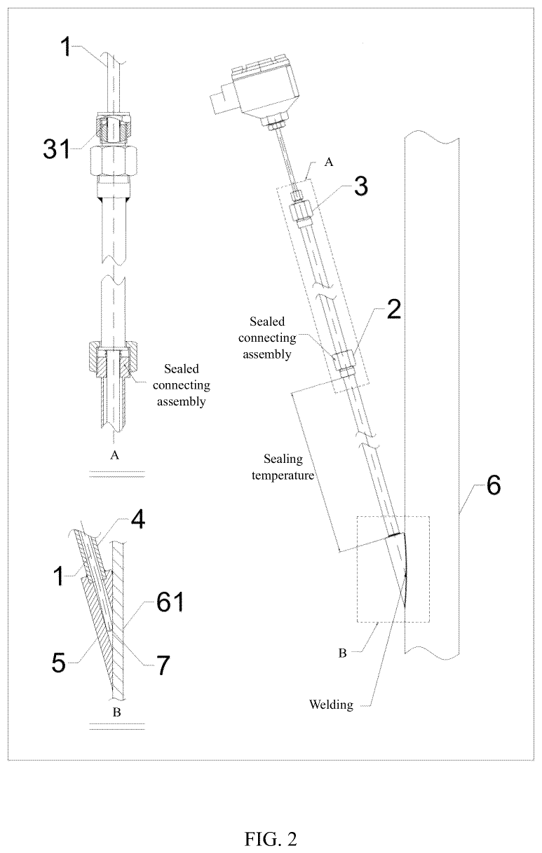

The overall structure diagrams 1 and 2 of this embodiment also show the detailed diagrams of the welding end of the socket contact type temperature measurement component 5 and the COT furnace tube 6 and the detailed diagrams of the clamping sleeve component 3, and further refer to FIG. 2, the welding surface of the socket contact type temperature measurement component 5 is processed into a curved surface according to the outer diameter of the COT furnace tube 6, so that the socket contact type temperature measurement component 5 is attached to the wall 61 of the COT furnace tube. The other end of the socket contact type temperature measurement component 5 is provided with a concentric counter bore matched with the sleeve 4. The sleeve 4 is connected to the socket contact type temperature measurement component 5. The sleeve and the sleeve are provided with concentric inner bores. The bore diameter of the concentric counter bore is matched with the outer diameter of the sleeve 4. The bore depth is 7 to 10 mm, the concentric inner bores are through holes, the bore diameter is 10 mm, and the thermocouple wire 1 penetrates through.

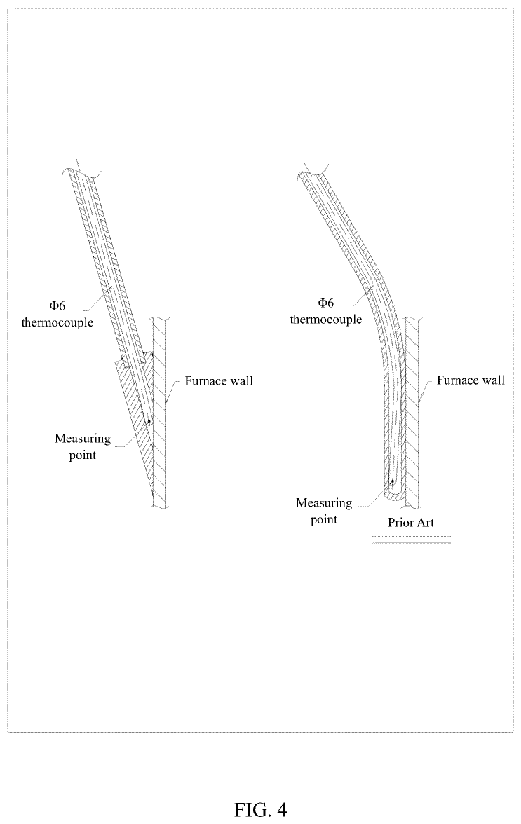

Referring to the FIG. 4, the comparison graph of the COT surface thermocouple measuring point position of the invention and the prior art shows that a thermocouple wire 1 sequentially passes through a clamping sleeve component 2, an upper cutting sleeve and a lower cutting sleeve and finally enters a sleeve contact type temperature measuring component 5. The thermocouple wire 1 is adjusted to be inserted to the bottom and tightly contacted with a COT furnace tube wall 61, and then a sealing double clamping sleeve 31 is screwed, fixed and sealed. The contact position of the thermocouple wire 1 and the COT furnace tube surface 61 is a measuring point 7. The diameter of the thermocouple can be selected according to the actual working condition, and the thermocouple wire 1 with the diameter of 6 is selected in the present example. Compared with the prior art, the sleeve contact type temperature measuring component 5 is not provided in the existing scheme, the thermocouple wire 1 can be bent in the sleeve, the controllability is extremely poor, the measuring point cannot touch the surface 61 of the COT furnace tube, and the application effect is poor. The COT surface thermocouple structure is convenient to install and maintain, can be replaced on line and is long in service life. According to the COT surface thermocouple, the contact surface of the sleeve contact type temperature measuring component 5 and the COT furnace tube surface 61 is a curved surface, so that the welding is convenient, and the strength is higher after the welding; the sleeve contact type temperature measuring component 5 and the surface 61 of the COT furnace tube can form any included angle, so that the situation that a thermocouple cannot be installed due to an overlarge included angle is avoided; the measuring point 7 (temperature measuring end) is directly and tightly contacted with the surface 61 of the COT furnace tube, so that the thermal response time is short, the precision is high, and the temperature measurement is more accurate; the sleeve contact type temperature measuring component 5 is directly welded on the furnace tube, so that the sleeve 4 is prevented from bending, and the thermocouple is greatly convenient to install.

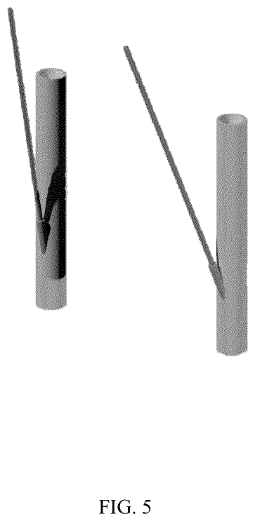

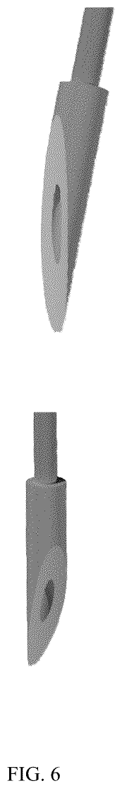

FIG. 5 is a schematic view of the oblique installation of the contact temperature measurement component of the disclosure; FIG. 6 is a schematic view of the design of different curved surfaces of the lower end of the contact temperature measurement component according to the disclosure. The inclination of the contact temperature measuring component is variable, and the contact temperature measuring component and the furnace tube are radially and axially connected in different forms according to the diameter. The structural form and the installation space of the furnace tube, so that the installation is realized under the condition that the sleeve is not bent, and the integral installation requirement of the process equipment is met. The design of different curved surfaces at the lower end of the contact temperature measuring component is designed according to the inclination angle of the contact temperature measuring component and the furnace tube, and the curved surfaces are matched with the outer wall of the furnace tube to ensure the tight fit.

It should be noted that the clamping sleeve component 3 is a ferrule bolt structure, and a sealed dual ferrule 31 is arranged in the clamping sleeve component, mainly for sealing connection and fixation, and in addition, when the thermocouple needs to be replaced online, the threads of the ferrule are directly unscrewed to draw out the thermocouple for replacement. Stainless steel bar materials are selected for the socket contact type temperature measuring component 5, stainless steel tubes are used for the sleeve 4, and the requirements of actual working conditions on the material, nominal diameter and wall thickness grade are met. The junction box 8 is a conventional product and is in accordance with the national standards of protection and explosion prevention, ½ ‘NPT, ¾’ NPT is used as an electrical interface, and a wiring terminal base is arranged in the junction box 8.

The above description is only for the preferred embodiment of the disclosure, but the disclosure should not be limited to the embodiment and the disclosure of the drawings, and therefore, all equivalent or modifications that do not depart from the spirit of the disclosure are intended to fall within the scope of the disclosure.

What is claimed is:

1. An outlet temperature of the ethylene cracking furnace (COT) surface thermocouple, comprising:
a contact type temperature measuring component, a sleeve, a connecting sealing component, a clamping sleeve component, a temperature measuring component and a junction box;
wherein the COT surface thermocouple is arranged on a surface of a furnace tube of an ethylene cracking furnace; the contact type temperature measuring component is completely in contact welding with the surface of the furnace tube; a whole body is in an inclined angle; the contact type temperature measuring component is connected with the sleeve in a concentric welding counter bore or a connecting internal thread; the sleeve and the contact type temperature measuring component are in concentric non-bending connection; the sleeve is formed by splicing two sections; the two sections of sleeves are connected through the connecting sealing component to form a sealing cavity; and the sleeve is connected with the clamping sleeve component.

2. The COT surface thermocouple of claim 1, wherein the contact temperature measurement component is an arc-shaped curved surface according to the outer diameter of the furnace tube and a given installation space, so that the contact temperature measurement component is completely fitted with the surface of the furnace tube.

3. The COT surface thermocouple of claim 1, wherein the contact temperature measurement component and a section of the sleeve are wrapped in an insulation layer along with a furnace tube of the cracking furnace, and the insulation layer is exposed outside the first section of the sleeve by 50 mm.

4. The COT surface thermocouple of claim 1, wherein the temperature measuring component is mounted in the sleeve, and a measuring point at the end of the temperature measuring component is in close contact with the surface of the furnace tube through an inner hole inclined surface of the contact temperature measuring component.

5. The COT surface thermocouple of claim 1, wherein the clamping sleeve component is a ferrule bolt structure.

6. The COT surface thermocouple of claim 1, wherein the contact temperature measurement component is made of stainless steel bar stock, hexagonal stock or tetragonal stock, and is designed and finished according to the diameter of the furnace tube and the given installation space.

7. The COT surface thermocouple of claim 1, wherein the junction box conforms to the national standards for protection and explosion protection, the electrical interface uses ½″ NPT, ¾″ NPT, and the junction box has a built-in terminal block.
